(19) United States
(12) Patent Application Publication
(10) Pub. No.: US 2023/0187739 A1
(43) Pub. Date: Jun. 15, 2023

(54) SECONDARY BATTERY

(71) Applicant: SK On Co., Ltd., Seoul (KR)

(72) Inventors: Young Ha KIM, Daejeon (KR); Ji Hyung KIM, Daejeon (KR); Sang Bin LEE, Daejeon (KR); Ho Jin HWANG, Daejeon (KR)

(21) Appl. No.: 17/994,111

(22) Filed: Nov. 25, 2022

(30) Foreign Application Priority Data
Dec. 14, 2021 (KR) 10-2021-0179104

(51) Int. Cl. H01M 50/105; H01M 50/46; H01M 50/178; H01M 50/54

(52) U.S. Cl. CPC H01M 50/105; H01M 50/46; H01M 50/178; H01M 50/54

(57) ABSTRACT

A secondary battery includes: a plurality of electrode assemblies, each of the plurality of electrode assemblies comprising a positive electrode, a negative electrode, and a separator; a plurality of electrode tabs formed to be extended from the electrode assemblies; a plurality of electrode leads electrically connected to the plurality of electrode tabs; and a pouch accommodating the plurality of electrode assemblies. In the plurality of electrode assemblies, the electrode tabs of the same electrodes are electrically connected to each other, and the plurality of electrode leads comprises three or more electrode leads.

### CROSS-REFERENCE TO RELATED APPLICATION

The present application claims priority under 35 U.S.C. § 119(a) to Korean patent application number 10-2021-0179104 filed on Dec. 14, 2021, in the Korean Intellectual Property Office, the entire disclosure of which is incorporated by reference herein.

### BACKGROUND

### Field of Invention

The present disclosure generally relates to a secondary battery, and more particularly, to a long-width secondary battery having a novel tab structure.

### Description of Related Art

With the development of electronics, communication and space industries, demand for secondary batteries as an energy power source is rapidly increasing. In particular, as the importance of global eco-friendly policies is emphasized, the electric vehicle market is growing rapidly, and research and development on secondary batteries is being actively conducted at home and abroad.

In particular, in order to load a secondary battery into a vehicle, while it is required to improve energy density and solve issues of spatial constraints, a (ultra) long-width secondary battery with a long width not only has high energy density due to its long width, but also has an advantageous aspect in terms of spatial efficiency because the battery pack may be more easily disposed on the floor of the vehicle, and thus research is being actively conducted.

However, a (ultra) long-width secondary battery with a long width has an issue in that as the length between the electrode tabs increases, the path of current becomes longer and internal resistance increases. Accordingly, power loss may increase and the performance of the secondary battery may be lowered, thereby reducing the lifespan. Accordingly, in a (ultra) long-width secondary battery having a high energy density, a technology capable of reducing the internal resistance is required.

### SUMMARY

Embodiments provide a secondary battery with a long width, which reduces the internal resistance of the secondary battery and improves processability through utilization of an existing production line.

In accordance with an aspect of the present disclosure, there is provided a secondary battery including: a plurality of electrode assemblies, each of the plurality of electrode assemblies comprising a positive electrode, a negative electrode, and a separator; a plurality of electrode tabs formed to be extended from the electrode assemblies; a plurality of electrode leads electrically connected to the plurality of electrode tabs; and a pouch accommodating the plurality of electrode assemblies, wherein, in the plurality of electrode assemblies, the electrode tabs of the same electrodes are electrically connected to each other, and the plurality of electrode leads comprises three or more electrode leads.

In an embodiment, the plurality of electrode leads may respectively protrude to an outside of any one side of the pouch.

In an embodiment, the plurality of electrode leads may respectively protrude to an outside of one side of the pouch or another side of the pouch facing the one side.

In an embodiment, the plurality of electrode leads may respectively protrude to an outside of one side of the pouch or another side of the pouch not facing the one side.

In an embodiment, the plurality of electrode leads may include a first electrode lead, a second electrode lead, and a third electrode lead, and the first electrode lead and the third electrode lead may have different electrodes from the second electrode lead.

In an embodiment, the plurality of electrode leads may include a first electrode lead, a second electrode lead, and a third electrode lead, and the first electrode lead and the third electrode lead may be positive electrode leads, and the second electrode lead may be a negative electrode lead.

In an embodiment, the plurality of electrode leads may include a positive electrode lead and a negative electrode lead, and the first electrode lead and the third electrode lead may be negative electrode leads, and the second electrode lead may be a positive electrode lead.

In an embodiment, at least one electrode lead of the plurality of electrode leads may be electrically connected to at least one electrode tab of the plurality of electrode tabs.

In an embodiment, at least one electrode lead of the plurality of electrode leads may be electrically connected to at least two or more electrode tabs electrically connected to the same electrodes among the plurality of electrode tabs.

In an embodiment, the at least two or more electrode tabs may be disposed side by side on one surface of the at least one electrode lead to be electrically connected to each other.

In an embodiment, the at least two or more electrode tabs may be respectively disposed on both surfaces facing each other of the at least one electrode lead to be electrically connected.

In accordance with an aspect, a length of a width of the secondary battery may be 500 mm or more.

According to an embodiment of the present disclosure, it is possible to provide a secondary battery having a long width, which reduces the internal resistance of the secondary battery and improves processability through utilization of an existing production line.

### BRIEF DESCRIPTION OF THE DRAWINGS

Example embodiments will now be described more fully hereinafter with reference to the accompanying drawings; however, they may be embodied in different forms and should not be construed as limited to the embodiments set forth herein. Rather, these embodiments are provided so that this disclosure will be thorough and complete, and will fully convey the scope of the example embodiments to those skilled in the art.

In the drawing figures, dimensions may be exaggerated for clarity of illustration. It will be understood that when an element is referred to as being “between” two elements, it can be the only element between the two elements, or one or more intervening elements may also be present. Like reference numerals refer to like elements throughout.

FIG. 1 illustrates a plan view of a secondary battery in accordance with an embodiment of the present disclosure.

FIG. 2 illustrates a perspective view in which a plurality of electrode assemblies are disposed side by side.

FIG. 3 illustrates a perspective view of a plurality of electrode assemblies electrically connected in a pouch.

FIG. 4 illustrates a perspective view of a plurality of electrode leads all protruding to the outside of the same one side of a pouch.

FIG. 5 illustrates a perspective view of a plurality of electrode leads respectively protruding to the outside of one side or another side facing the one side of a pouch.

FIG. 6 illustrates a perspective view of a plurality of electrode leads respectively protruding to the outside of one side or another side not facing the one side of a pouch.

FIG. 7 illustrates a plan view in which a negative electrode of each of a plurality of electrode assemblies is disposed to face each other.

FIG. 8 illustrates a plan view in which a positive electrode of each of a plurality of electrode assemblies is disposed to face each other.

FIG. 9 illustrates a plan view of a secondary battery having two positive electrode leads and one negative electrode lead.

FIG. 10 illustrates a plan view of a secondary battery having two negative electrode leads and one positive electrode lead.

FIG. 11 illustrates a cross-sectional view of a secondary battery according to an embodiment.

FIG. 12 illustrates an enlarged view of area B of FIG. 11 in which a plurality of electrode tabs are disposed side by side on one surface of an electrode lead.

FIG. 13 illustrates an enlarged view of area B of FIG. 11 in which a plurality of electrode tabs are respectively disposed on both surfaces of an electrode lead.

FIG. 14 illustrates a perspective view of a secondary battery including two electrode assemblies.

FIG. 15 illustrates a perspective view of a secondary battery including three electrode assemblies.

### DETAILED DESCRIPTION

The specific structural or functional description disclosed herein is merely illustrative for the purpose of describing embodiments according to the concept of the present disclosure. The embodiments according to the concept of the present disclosure can be implemented in various forms, and cannot be construed as limited to the embodiments set forth herein.

The present disclosure relates to a long width secondary battery having a novel tab structure.

Hereinafter, a secondary battery according to an embodiment will be described with reference to the accompanying drawings.

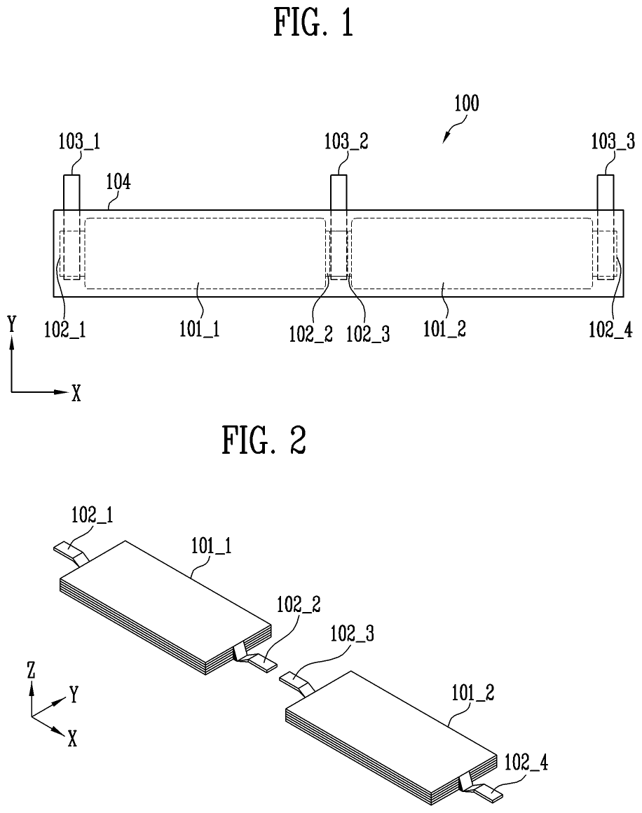

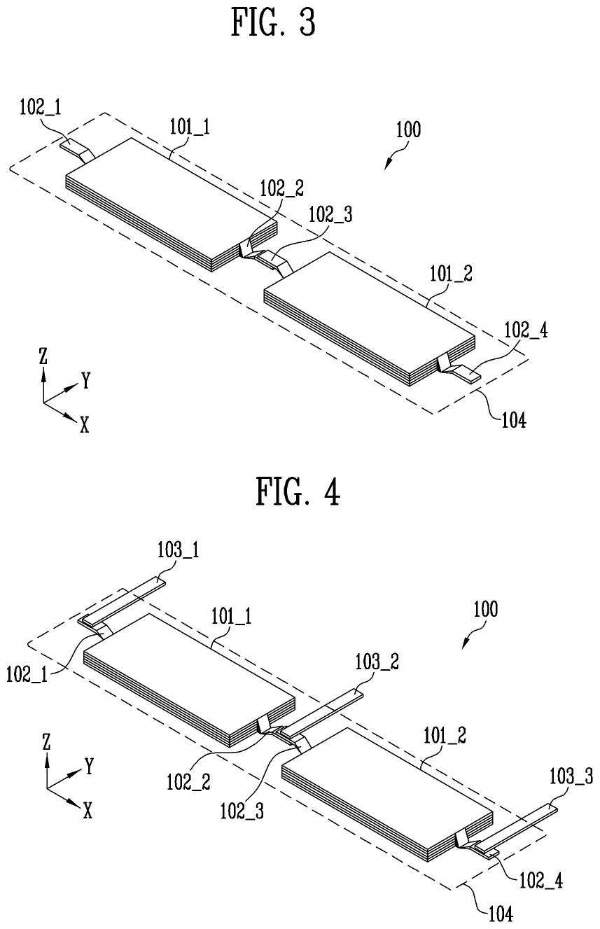

FIG. 1 illustrates a plan view of a secondary battery 100 in accordance with an embodiment of the present disclosure, FIG. 2 illustrates a perspective view in which a plurality of electrode assemblies 101_1 and 101_2 are disposed side by side, and FIG. 3 illustrates a perspective view of the plurality of electrode assemblies 101_1 and 101_2 electrically connected in a pouch 104.

Referring to FIG. 1, the secondary battery 100 according to an embodiment of the present disclosure may include an electrode assembly 101, an electrode tab 102, an electrode lead 103, and the pouch 104.

Referring to FIGS. 1 to 3, the electrode assembly 101 may include a plurality of electrode assemblies 101. For example, at least two or more electrode assemblies 101 may be included, and a first electrode assembly 101_1 and a second electrode assembly 101_2 may be included. Although only two electrode assemblies 101_1 and 101_2 are illustrated in FIGS. 1 to 3, the number of electrode assemblies 101 is not limited thereto.

The plurality of electrode assemblies 101_1 and 101_2 may be arranged side by side in one direction and electrically connected to each other to form the secondary battery 100 with a long width. For example, the first electrode assembly 101_1 and the second electrode assembly 101_2 may be disposed side by side in one direction (e.g., X direction) in the pouch 104.

The electrode assembly 101 has a stacked structure, and may be formed by alternately stacking a positive electrode and a negative electrode with a separator interposed therebetween. However, the present invention is not limited thereto, and the electrode assembly 101 may be formed in various methods and shapes, such as a jelly roll (winding type) structure.

Although not shown in the drawings, the positive electrode of the electrode assembly 101 may include a positive electrode current collector and a positive electrode active material layer formed on the positive electrode current collector. A positive electrode uncoated region may be formed on a part of the positive electrode current collector on which the positive electrode active material layer is not formed. A positive electrode tab, which will be described later, may be formed by cutting the positive electrode uncoated region or may be formed by coupling a separate conductive member to the positive electrode uncoated region. When the positive electrode tab is formed by coupling a separate conductive member to the positive electrode uncoated region, welding, for example, ultrasonic welding, or the like may be used. The positive electrode uncoated region may be electrically connected to the positive electrode tab to allow electrons collected in the positive electrode current collector to flow to an external circuit.

The positive electrode current collector may be formed of a material having excellent electrical conductivity, and the positive electrode tab may be formed of the same material as the positive electrode current collector. For example, the positive electrode current collector and the positive electrode tab may be formed of a material such as aluminum (Al). A chalcogenide compound may be used for the positive electrode active material layer so that lithium ions may be intercalated or deintercalated, for example, it may be formed using composite metal oxides such as LiCoO2, LiMn2O4, LiNiO2, LiNi1-xCoxO2 (0<x<1), LiMnO2, and the like.

The negative electrode of the electrode assembly 101 may include a negative electrode current collector for collecting electrons generated by a chemical reaction, and a negative electrode active material layer formed on the negative electrode current collector. A negative electrode uncoated region may be formed on a part of the negative electrode current collector on which the negative electrode active material layer is not formed. The negative electrode tab to be described later may be formed by cutting the negative electrode uncoated region or may be formed by coupling a separate conductive member to the negative negative uncoated region. When a separate conductive member is coupled to the negative electrode uncoated region to form the negative electrode tab, welding, for example, ultrasonic welding, or the like may be used. The negative electrode uncoated region may be electrically connected to the negative electrode tab to allow electrons collected in the negative electrode current collector to flow to an external circuit.

The negative electrode current collector may be formed of a material having excellent electrical conductivity, for example, copper (Cu) or nickel (Ni). The negative electrode tab may be formed of, for example, nickel (Ni). The negative electrode active material layer may be formed of a carbon (C) based material in which lithium ions may be intercalated and deintercalated, for example, a material such as silicon (Si), tin (Sn), tin oxide, tin alloy composite, transition metal oxide, lithium metal nitride or lithium metal oxide

The separator of the electrode assembly 101 may be formed between the positive electrode and the negative electrode to prevent the positive electrode and the negative electrode from directly contacting each other. In other words, the separator blocks the positive electrode and the negative electrode, thereby preventing a short that may occur between the positive electrode and the negative electrode. The separator may be formed in a porous structure in which electric charges (e.g., lithium ions) may move. For example, the separator may be formed of a thermoplastic resin such as polyethylene (PE) or polypropylene (PP). When the temperature inside the battery rises, near the melting point of the thermoplastic resin, the separator formed with a porous structure melts and the pores are blocked to become an insulating film (separator sealing or shutdown phenomenon). By changing the separator to an insulating film, the movement of lithium ions between the positive electrode and the negative electrode is blocked, and current cannot flow any more, so that the temperature rise inside the battery may be stopped.

The electrode assembly 101 may be electrically connected to the electrode tab 102.

The electrode tab 102 may include a plurality of electrode tabs 102. For example, the plurality of electrode tabs 102 may include a first electrode tab 102_1, a second electrode tab 102_2, a third electrode tab 102_3, and a fourth electrode tab 102_4. Although only four electrode tabs 102_1, 102_2, 102_3, 102_4 are illustrated in FIGS. 1 to 3, the number of electrode tabs 102 is not limited thereto.

The electrode tab 102 may include a positive electrode tab and a negative electrode tab, and may be respectively connected to the positive electrode and the negative electrode of the electrode assembly 101 to form a path through which electrons may move. One electrode assembly 101 may be electrically connected to at least two or more electrode tabs 102. For example, the first electrode assembly 101_1 may be electrically connected to the first electrode tab 102_1 and the second electrode tab 102_2, respectively. The first electrode tab 102_1 may be connected to the positive electrode of the first electrode assembly 101_1, and the second electrode tab 102_2 may be connected to the negative electrode of the first electrode assembly 101_1, respectively, or the first electrode tab 102_1 may be connected to the negative electrode of the first electrode assembly 101_1, and the second electrode tab 102_2 may be connected to the positive electrode of the first electrode assembly 1011, respectively, but is not limited thereto. The second electrode assembly 101_2 may be electrically connected to the third electrode tab 102_3 and the fourth electrode tab 102_4, respectively. The third electrode tab 102_3 may be connected to the positive electrode of the second electrode assembly 101_2, and the fourth electrode tab 102_4 may be connected to the negative electrode of the second electrode assembly 101_2, respectively, or, the third electrode tab 102_3 may be connected to the negative electrode of the second electrode assembly 101_2, and the fourth electrode tab 102_4 may be connected to the positive electrode of the second electrode assembly 1012, respectively, but is not limited thereto.

The first electrode assembly 101_1 electrically connected to the first and second electrode tabs 102_1, 102_2 may be electrically connected to the second electrode assembly 1012 electrically connected to the third and fourth electrode tabs 102_3, 102_4. The first electrode assembly 101_1 and the second electrode assembly 101_2 may be electrically connected by the electrode tab 102 of the same electrodes. For example, when the first electrode tab 102_1 of the first electrode assembly 101_1 is a negative electrode tab, the second electrode tab 102_2 is a positive electrode tab, and the third electrode tab 102_3 of the second electrode assembly 101_2 is a positive electrode tab, and the fourth electrode tab 102_4 is a negative electrode tab, the first electrode assembly 101_1 and the second electrode assembly 101_2 may be electrically connected to each other by the electrical connection between the second electrode tab 102_2 and the third electrode tab 102_3 that are the positive electrode tabs. Alternatively, when the first electrode tab 102_1 of the first electrode assembly 101_1 is a positive electrode tab, the second electrode tab 102_2 is a negative electrode tab, and the third electrode tab 102_3 of the second electrode assembly 101_2 is a negative electrode tab, and the fourth electrode tab 102_4 is a positive electrode tab, the first electrode assembly 101_1 and the second electrode assembly 101_2 may be electrically connected to each other by the electrical connection between the second electrode tab 102_2 and the third electrode tab 102_3 that are the negative electrode tabs, but the method of electrically connecting the first electrode assembly 101_1 and the second electrode assembly 101_2 is not limited thereto.

The electrode tab 102 may be electrically connected to the electrode lead 103. The electrode lead 103 is electrically connected to the electrode assembly 101 and the electrode tab 102, and is exposed to the outside of the pouch 104, and may serve as an electrode terminal that may be electrically connected to other batteries or external devices.

The electrode lead 103 may include a plurality of electrode leads 103. The plurality of electrode leads 103 forming the long width secondary battery 100 may be at least three or more. For example, the plurality of electrode leads 103 may include a first electrode lead 103_1, a second electrode lead 103_2, and a third electrode lead 103_3. Although only three electrode leads 103_1, 103_2, 103_3 are illustrated in FIG. 1, the number of electrode leads 103 is not limited thereto.

At least one electrode lead 103 of the plurality of electrode leads 103 may be electrically connected to at least one electrode tab 102 of the plurality of electrode tabs 102. For example, at least one electrode lead 103 may be electrically connected to at least one electrode tab 102. The first electrode lead 103_1 may be electrically connected to the first electrode tab 102_1, and the third electrode lead 103_3 may be electrically connected to the fourth electrode tab 102_4. In addition, at least one electrode lead 103 of the plurality of electrode leads 103 may be electrically connected to at least two or more electrode tabs 102 electrically connected to the same electrodes among the plurality of electrode tabs 102. For example, the second electrode lead 103_2 may be electrically connected to the second electrode tab 102_2 and the third electrode tab 102_3, but is not limited thereto.

The electrode lead 103 may include a positive electrode lead and a negative electrode lead. The positive electrode lead may be connected to the positive electrode tab, and the negative electrode lead may be connected to the negative electrode tab. The material of the positive electrode lead and the negative electrode lead may be different from each other. For example, the positive electrode lead may be made of the same material as the positive electrode, such as aluminum (Al), and the negative electrode lead may be made of the same material as the negative electrode, such as copper (Cu) or nickel (Ni) coated copper.

The electrode lead 103 may be connected to the electrode tab 102 using, for example, spot welding or the like.

In the present disclosure, being electrically connected may be performed by various methods. For example, they may be electrically connected by soldering or ultrasonic bonding, etc., may be electrically connected by directly contacting with each other, or may be electrically connected by indirectly contacting each other. Electrical connection may be any method as long as a current may flow by forming a path through which electrons may move, and is not limited to a specific method.

The pouch 104 may accommodate the electrode assembly 101, an electrolyte (not shown), the electrode tab 102, and a part of the electrode lead 103 may be accommodated inside the pouch 104, and the other part may be disposed to protrude to the outside of the pouch 104. The pouch 104 may protect internal components such as the electrode assembly 101 and the electrolyte, and may perform a function of complementing the electrochemical properties of the electrode assembly 101 and the electrolyte and dissipating heat.

The pouch 104 may be made of a flexible material, and although not shown in the drawings, may be formed of an outer layer (not shown), a metal layer (not shown), and an inner layer (not shown). The outer layer is a base material and a protective layer, and may primarily protect the electrode assembly 101 from external impact and etc. The outer layer may be formed of, for example, a polymer material such as nylon or polyethylene terephthalate (PET), but is not limited thereto. The metal layer may serve as a substrate maintaining mechanical strength and a barrier layer preventing penetration of moisture and oxygen, and may be formed of a material such as aluminum (Al), but is not limited thereto. The inner layer is also called a heat-sealing layer, and has heat-adhesive properties and may serve as a sealing agent. The inner layer may be formed of a polyolefin-based resin material, and may act as an adhesive layer using casted polypropylene (CPP), which is a modified polypropylene. The inner layer may be formed of a material selected from the group consisting of polyolefin-based resin such as chlorinated polypropylene, polyethylene, ethylene propylene copolymer, polyethylene and acrylic acid copolymer, and polypropylene and acrylic acid copolymer, but is not limited thereto.

In order to sufficiently accommodate the plurality of electrode assemblies 101 disposed side by side in one direction (e.g., X direction) and the plurality of electrode tabs 102 in the internal space, the pouch 104 may have a long width in the same direction (e.g., X direction) as the direction in which the plurality of electrode assemblies 101 are disposed side by side. The secondary battery 100 of the present disclosure may correspond to the pouch 104 having a long width to form the secondary battery 100 having a long width in the one direction (e.g., X direction).

In installing the battery pack under the vehicle, a battery pack may be configured by arranging a plurality of general-type secondary batteries that are not long in width in one direction (e.g., X direction) to correspond to the width of the vehicle, but in this case, as the number of batteries increases, issues such as an increase in the number of parts, a decrease in productivity, and an increase in cost occur, and there is a limit to realizing a high capacity of the secondary battery. On the other hand, according to the present disclosure, by forming a secondary battery having a long width in one direction (e.g., X direction) that may correspond to the width of the vehicle, not only the number of parts may be reduced, productivity may be improved and cost may be reduced, and energy density may also be improved according to a long width.

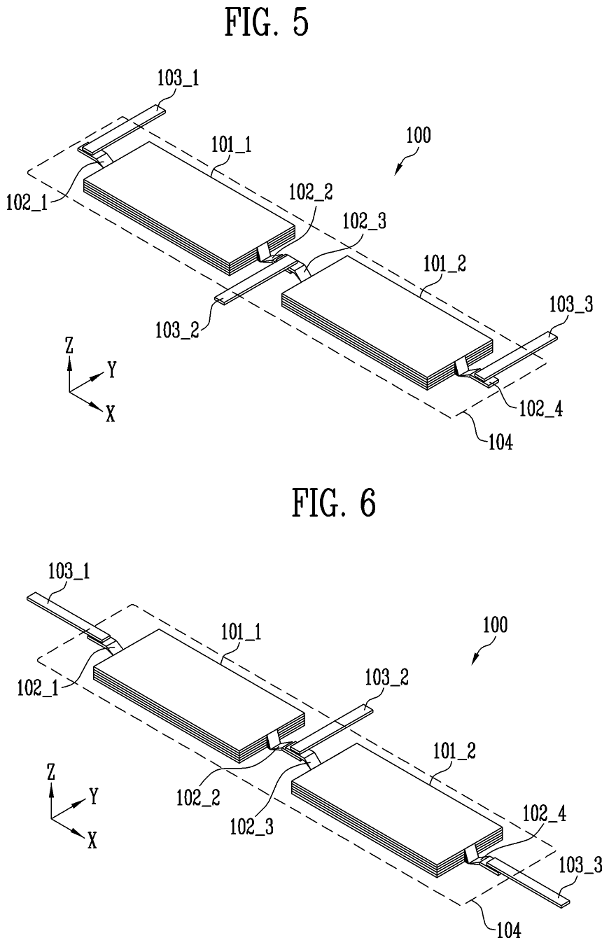

FIG. 4 illustrates a perspective view of the plurality of electrode leads 103 all protruding to the outside of the same one side of the pouch 104, FIG. 5 illustrates a perspective view of the plurality of electrode leads 103 respectively protruding to the outside of one side or another side facing the one side of the pouch 104, and FIG. 6 illustrates a perspective view of the plurality of electrode leads 103 respectively protruding to the outside of one side or another side not facing the one side of the pouch 104.

Referring to FIGS. 4 to 6, the secondary battery 100 according to an embodiment of the present disclosure may include the plurality of electrode leads 103, and the plurality of electrode leads 103 may be disposed such that a part thereof protrudes to the outside of the pouch 104. For example, a part of the first electrode lead 103_1 may be positioned inside the pouch 104, another part of the first electrode lead 103_1 may be disposed to be positioned outside the pouch 104, a part of the second electrode lead 103_2 may be positioned inside the pouch 104, another part of the second electrode lead 103_2 may be disposed to be positioned outside the pouch 104, a part of the third electrode lead 103_3 may be positioned inside the pouch 104, and another part of the third electrode lead 103_3 may be disposed to be positioned outside the pouch 104.

Referring to FIG. 4, all of the plurality of electrode leads 103 may protrude to the outside of the same one side of the pouch 104. For example, the first to third electrode leads 103_1, 103_2, 103_3 may be disposed side by side in one direction (e,g., X direction) to protrude to the outside of the same one side of the pouch 104.

Referring to FIGS. 5 and 6, the plurality of electrode leads 103 may protrude to the outside of different sides of the pouch 104 from each other. For example, referring to FIG. 5, the first to third electrode leads 103_1, 103_2, 103_3 may be disposed in a zigzag in one direction (e.g., X direction), so that the first electrode lead 103_1 and the third electrode lead 103_3 may be disposed to protrude to the outside of the same one side of the pouch 104, and that the second electrode lead 103_2 may be disposed to protrude to the outside of another side of the pouch 104 facing the one side in another direction (e.g., Y direction). In addition, referring to FIG. 6, the first to third electrode leads 103_1, 103_2, 103_3 may be disposed in a direction perpendicular to each other, so that the first electrode lead 103_1 and the third electrode lead 103_3 may be disposed to protrude to the outside, respectively, on both sides facing each other in one direction (e.g., X direction) of the pouch 104, and that the second electrode lead 103_2 may be disposed to protrude to the outside of another side of the pouch 104 not facing the both sides, but is not limited thereto.

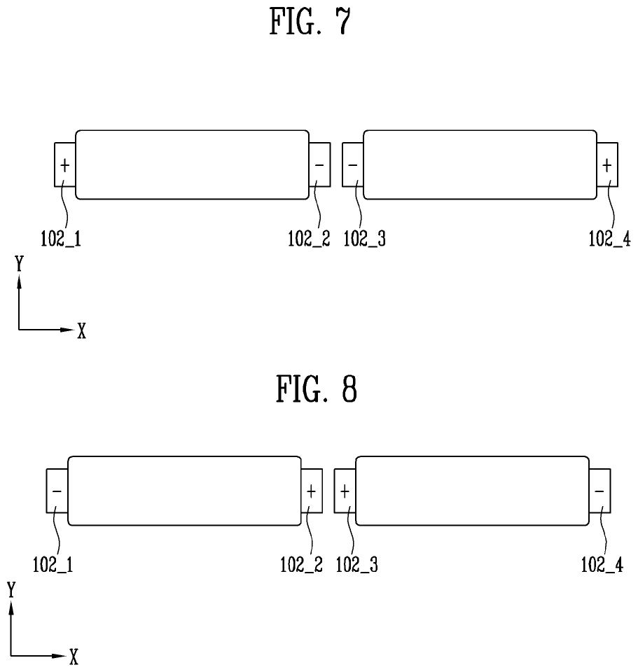

FIG. 7 illustrates a plan view in which a negative electrode of each of the plurality of electrode assemblies 101 is disposed to face each other, and FIG. 8 illustrates a plan view in which a positive electrode of each of the plurality of electrode assemblies 101 is disposed to face each other.

Referring to FIGS. 7 and 8, the plurality of electrode assemblies 101 electrically connected to the plurality of electrode tabs 102 having different electrodes may be disposed side by side in one direction (e.g., X direction) so that the same electrodes face each other. For example, the first electrode assembly 101_1 electrically connected to the first electrode tab 102_1 of the positive electrode and the second electrode tab 102_2 of the negative electrode and the second electrode assembly 101_2 electrically connected to the third electrode tab 102_3 of the negative electrode and the fourth electrode tab 102_4 of the positive electrode, may be disposed side by side in one direction (e.g., X direction), so that the second electrode tab 102_2 of the negative electrode faces the third electrode tab 102_3 of the negative electrode, and, the first electrode assembly 101_1 electrically connected to the first electrode tab 102_1 of the negative electrode and the second electrode tab 102_2 of the positive electrode and the second electrode assembly 101_2 electrically connected to the third electrode tab 102_3 of the positive electrode and the fourth electrode tab 102_4 of the negative electrode may be disposed side by side in one direction (e.g., X direction) so that the second electrode tab 102_2 of the positive electrode faces the third electrode tab 102_3 of the positive electrode, but is not limited thereto.

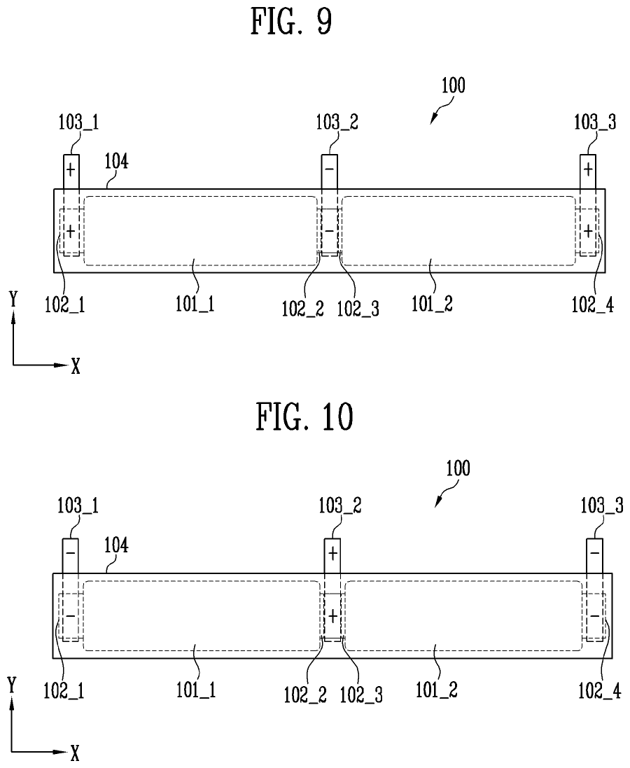

FIG. 9 illustrates a plan view of the secondary battery 100 having two positive electrode leads and one negative electrode lead, and FIG. 10 illustrates a plan view of the secondary battery 100 having two negative electrode leads and one positive electrode lead.

Referring to FIGS. 9 and 10, the plurality of electrode assemblies 101 electrically connected to the plurality of electrode tabs 102 may be electrically connected to each other. For example, a second electrode tab 102_2 electrically connected to the first electrode assembly 101_1 and a third electrode tab 102_3 electrically connected to the second electrode assembly 101_2 disposed to face each other may be electrically connected to each other. The second electrode tab 102_2 and the third electrode tab 102_3 may be connected in various ways, and may be electrically connected, for example, by soldering or ultrasonic bonding. In addition, the second electrode tab 102_2 and the third electrode tab 102_3 may be electrically connected by directly contacting with each other, or may be electrically connected by indirectly contacting each other, but is not limited thereto, and may depend on various contact methods.

The plurality of electrode tabs 102 including a positive electrode or a negative electrode may be electrically connected to the electrode leads 103 of the same electrodes, respectively, and may be accommodated in the pouch 104. A part of the electrode lead 103 may be connected to the electrode tab 102 and accommodated in the pouch, and the other part of the electrode lead 103 may protrude outside the pouch 104 to serve as an electrode terminal of the secondary battery 100. For example, the first electrode tab 102_1 of the positive electrode may be electrically connected to the first electrode lead 103_1 of the positive electrode, the second and third electrode tabs 102_2, 102_3 of the negative electrode may be electrically connected to the second electrode lead 103_2 of the negative electrode, and the fourth electrode tab 102_4 of the positive electrode may be electrically connected to the third electrode lead 103_3 of the positive electrode. The first electrode lead and the third electrode lead may serve as a positive terminal of the secondary battery 100, and the second electrode lead may serve as a negative terminal of the secondary battery 100. In addition, the first electrode tab 102_1 of the negative electrode may be electrically connected to the first electrode lead 103_1 of the negative electrode, the second and third electrode tabs 102_2, 102_3 of the positive electrode may be electrically connected to the second electrode lead 103_2 of the positive electrode, and the fourth electrode tab 102_4 of the negative electrode may be electrically connected to the third electrode lead 103_3 of the negative electrode. The first electrode lead and the third electrode lead may serve as a negative terminal of the secondary battery 100, and the second electrode lead may serve as a positive terminal of the secondary battery 100, but is not limited thereto.

The secondary battery 100 according to the present disclosure may include at least two or more electrode assemblies 101 and at least three or more electrode leads 103, and each electrode lead 103 may serve as an electrode terminal of a positive or negative electrode of the secondary battery 100. By including at least two or more electrode assemblies 101, the secondary battery 100 having a long width in one direction (e.g., X direction) may be formed, and in the case of the secondary battery 100 having such a long width, energy density may be increased.

On the other hand, when the length of the width of the secondary battery increases, as the flow of current also increases, the internal resistance may increase and the defect rate in the process may also increase. However, in the secondary battery 100 according to the present disclosure, the flow of current in one pouch 104 may be controlled in at least two directions by using at least three or more electrode leads 103 as electrode terminals, so the internal resistance may be reduced. In addition, in the secondary battery 100 according to the present disclosure to form the long secondary battery 100, by including at least two or more electrode assemblies 101, it is possible to increase the speed of the electrode process and the assembly process, as well as reduce the rate of quality defects, thereby improving process efficiency.

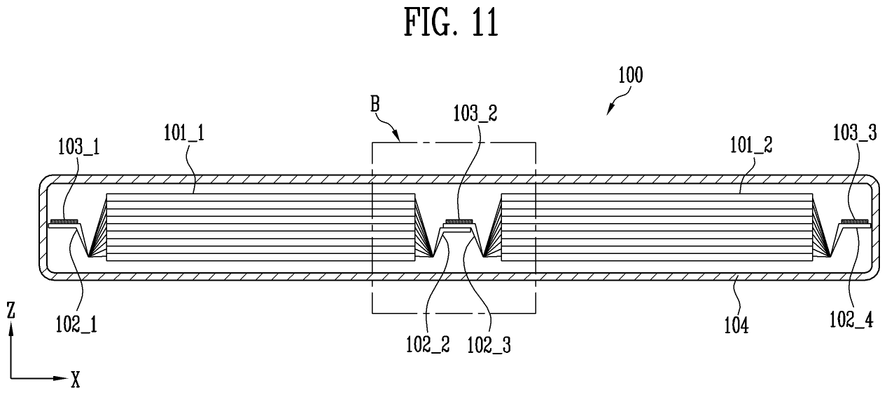

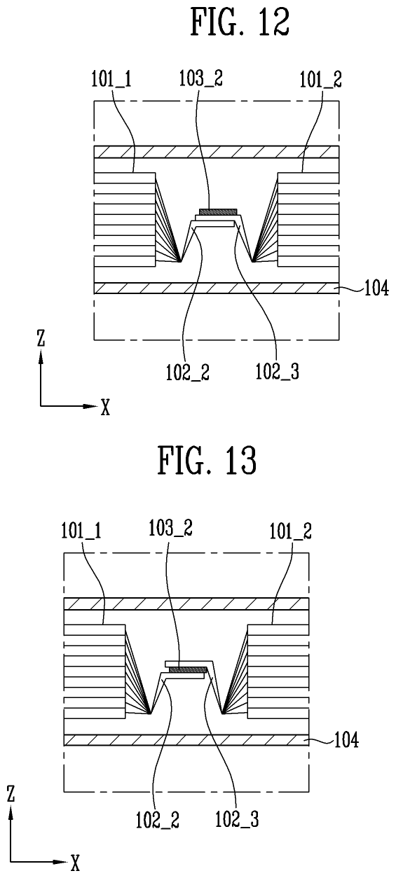

FIG. 11 illustrates a cross-sectional view of the secondary battery 100 according to an embodiment, FIG. 12 illustrates an enlarged view of area B of FIG. 11 in which the plurality of electrode tabs 102 are disposed side by side on one surface of an electrode lead 103, and FIG. 13 illustrates an enlarged view of area B of FIG. 11 in which the plurality of electrode tabs 102 are respectively disposed on both surfaces of an electrode lead.

Referring to FIGS. 11 to 13, the plurality of electrode assemblies 101 may be electrically connected to each other through the electrode tab 102 connected to each electrode assembly 101, and may be electrically connected to the electrode lead 103 at the same time. The plurality of electrode tabs 102 and the electrode leads 103 may be electrically connected to each other by welding or the like, but are not limited thereto. For example, the first electrode assembly 101_1 may be electrically connected to the second electrode assembly 101_2 through the second electrode tab 102_2 of the first electrode assembly 101_1 and the third electrode tab 102_3 of the second electrode assembly 101_2, and may also be electrically connected to the second electrode lead 103_2 at the same time. The second electrode tab 102_2, the third electrode tab 102_3, and the second electrode lead 103_2 may be connected in various ways, and may be electrically connected, for example, by soldering or ultrasonic bonding. In addition, the second electrode tab 102_2, the third electrode tab 102_3, and the second electrode lead 103_2 may be electrically connected by directly contacting each other, or may be electrically connected by indirectly contacting each other, but the present invention is not limited thereto, and various contact methods may be used.

Referring to FIG. 12, at least two or more electrode tabs 102 may be disposed side by side in a direction (e.g., Z direction) perpendicular to one direction (e.g., X direction) on one surface of at least one electrode lead 103 to be electrically connected. For example, the second electrode tab 102_2 of the first electrode assembly 101_1, the third electrode tab 102_3 of the second electrode assembly 101_2 and the second electrode lead 103_2 may be disposed side by side in the Z direction in the order of the second electrode tab 102_2, the third electrode tab 102_3, and the second electrode lead 103_2, to be electrically connected to each other through welding or the like, and may be electrically connected by directly contacting each other or by indirectly contacting each other.

Referring to FIG. 13, the at least two or more electrode tabs 102 may be respectively disposed on both surfaces facing each other of the at least one electrode lead 103 in a direction (e.g., Z direction) perpendicular to one direction (e.g., X direction) to be electrically connected. For example, the second electrode tab 102_2 of the first electrode assembly 101_1, the third electrode tab 102_3 of the second electrode assembly 101_2 and the second electrode lead 103_2 may be disposed side by side in the Z direction in the order of the second electrode tab 102_2, the second electrode lead 103_2, and the third electrode tab 102_3, to be electrically connected to each other through welding or the like, and may be electrically connected by directly contacting each other or by indirectly contacting each other.

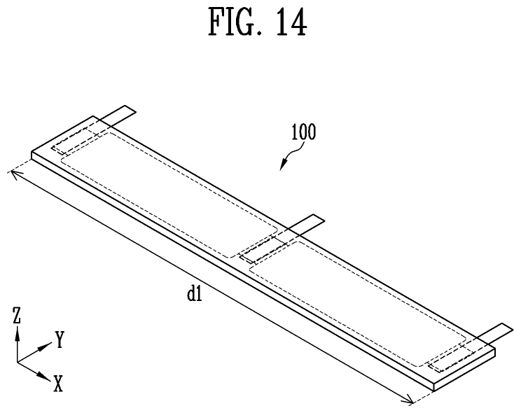

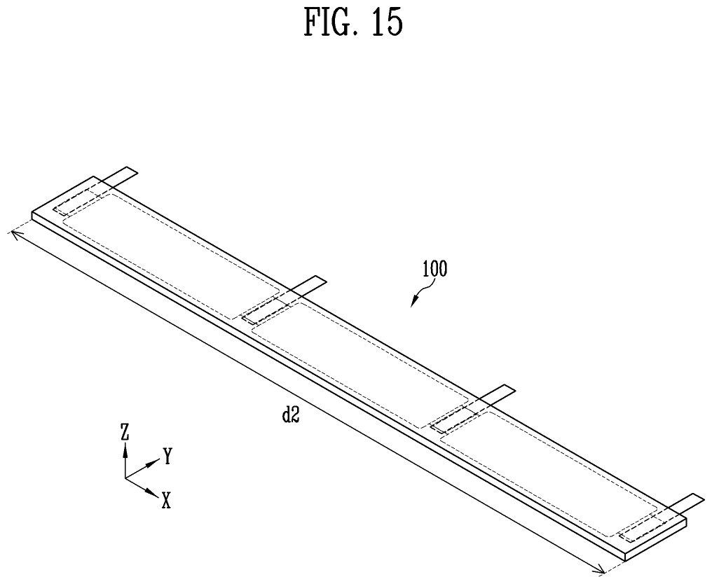

FIG. 14 illustrates a perspective view of the secondary battery 100 including two electrode assemblies 101_1, 101_2, and FIG. 15 illustrates a perspective view of the secondary battery 100 including three electrode assemblies 101_1, 101_2, 101_3.

Referring to FIGS. 14 and 15, the secondary battery 100 may include at least two or more electrode assemblies 101 in the one pouch 104, and may have a width of d1 or d2 in one direction (e.g., X direction). The secondary battery 100 is a (ultra) long width secondary battery 100 having a long width, and d1 or d2 may be 500 mm or more, but is not limited thereto, and may be appropriately adjusted according to the number of electrode assemblies 101 in the one pouch 104.

While the present disclosure has been shown and described with reference to certain exemplary embodiments thereof, it will be understood by those skilled in the art that various changes in form and details may be made therein without departing from the spirit and scope of the present disclosure as defined by the appended claims and their equivalents. Therefore, the scope of the present disclosure should not be limited to the above-described exemplary embodiments but should be determined by not only the appended claims but also the equivalents thereof.

In the above-described embodiments, all steps may be selectively performed or part of the steps and may be omitted. In each embodiment, the steps are not necessarily performed in accordance with the described order and may be rearranged. The embodiments disclosed in this specification and drawings are only examples to facilitate an understanding of the present disclosure, and the present disclosure is not limited thereto. That is, it should be apparent to those skilled in the art that various modifications can be made on the basis of the technological scope of the present disclosure.

Meanwhile, the exemplary embodiments of the present disclosure have been described in the drawings and specification. Although specific terminologies are used here, those are only to explain the embodiments of the present disclosure. Therefore, the present disclosure is not restricted to the above-described embodiments and many variations are possible within the spirit and scope of the present disclosure. It should be apparent to those skilled in the art that various modifications can be made on the basis of the technological scope of the present disclosure in addition to the embodiments disclosed herein.

What is claimed is:

1. A secondary battery comprising:
a plurality of electrode assemblies, each of the plurality of electrode assemblies comprising a positive electrode, a negative electrode, and a separator;
a plurality of electrode tabs formed to be extended from the electrode assemblies;
a plurality of electrode leads electrically connected to the plurality of electrode tabs; and
a pouch accommodating the plurality of electrode assemblies,
wherein, in the plurality of electrode assemblies, the electrode tabs of the same electrodes are electrically connected to each other, and
the plurality of electrode leads comprises three or more electrode leads.

2. The secondary battery of claim 1, wherein the plurality of electrode leads respectively protrude to an outside of any one side of the pouch.

3. The secondary battery of claim 1, wherein the plurality of electrode leads respectively protrude to an outside of one side of the pouch or another side of the pouch facing the one side.

4. The secondary battery of claim 1, wherein the plurality of electrode leads respectively protrude to an outside of one side of the pouch or another side of the pouch not facing the one side.

5. The secondary battery of claim 1, wherein the plurality of electrode leads comprise a first electrode lead, a second electrode lead, and a third electrode lead, and
wherein the first electrode lead and the third electrode lead have different electrodes from the second electrode lead.

6. The secondary battery of claim 1, wherein the plurality of electrode leads comprise a first electrode lead, a second electrode lead, and a third electrode lead, and
wherein the first electrode lead and the third electrode lead are positive electrode leads, and the second electrode lead is a negative electrode lead.

7. The secondary battery of claim 5, wherein the plurality of electrode leads comprise a positive electrode lead and a negative electrode lead, and
wherein the first electrode lead and the third electrode lead are negative electrode leads, and the second electrode lead is a positive electrode lead.

8. The secondary battery of claim 1, wherein at least one electrode lead of the plurality of electrode leads is electrically connected to at least one electrode tab of the plurality of electrode tabs.

9. The secondary battery of claim 1, wherein at least one electrode lead of the plurality of electrode leads is electrically connected to at least two or more electrode tabs electrically connected to the same electrodes among the plurality of electrode tabs.

10. The secondary battery of claim 9, wherein the at least two or more electrode tabs are disposed side by side on one surface of the at least one electrode lead to be electrically connected to each other.

11. The secondary battery of claim 9, wherein the at least two or more electrode tabs are respectively disposed on both surfaces facing each other of the at least one electrode lead to be electrically connected.

12. The secondary battery of claim 1, wherein a length of a width of the secondary battery is 500 mm or more.
